(19) United States
(12) Patent Application Publication
(10) Pub. No.: US 2007/0005365 A1
(43) Pub. Date: Jan. 4, 2007

(54) COMMUNICATING STATUS DATA

(75) Inventors: BRIAN D GOODMAN, Norwalk, CT (US); FRANK LAWRENCE JANIA, Chapel Hill, NC (US); JAMES KARL KEBINGER, Somerville, MA (US); DARREN MARK SHAW, Hampshire (GB)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: INTERNATIONAL BUSINESS MACHINES CORPORATION, Armonk, NY (US)

(21) Appl. No.: 11/426,973

(22) Filed: Jun. 28, 2006

(30) Foreign Application Priority Data
Jul. 2, 2005 (GB) 0513626.2

(51) Int. Cl. G10L 21/00

(52) U.S. Cl. 704/270

(57) ABSTRACT

A system for communicating status data associated with a first user to a second user, for use with a first data processing system associated with a plurality of status events of the first user and comprising a first communication component for communicating status event data associated with the plurality of status events. The system comprises: a status event handler for receiving communicated status event data; a weight component for determining weight data associated with the status event data; and a second communication component for communicating the weight data to a second data processing system.

### FIELD OF THE INVENTION

The present invention relates to a system, method, and computer program for communicating status data.

### BACKGROUND

Instant messaging (IM) enables a user to send and receive messages to and from other users in real time. An IM client software application runs on a first user's computer. When the first user is online, by being connected to a network such as the Internet, the IM client application opens a session with an IM server. The IM client application sends a user identification and password to log onto the IM server. The IM server uses a communication protocol that allows for IM functionality.

The IM client application includes a contact list, which is a list of other users that the first user wishes to have the ability to send messages to. When the users identified in the contact list log on to the IM server (i.e., when the users are online), the first user is notified, so that messages can be sent and received. A message is sent to the IM server, which then routes the message to the identified user. In some implementations of IM systems, messages are sent directly between the IM client applications and the IM server is not involved in the transfer of messages.

IM applications are used primarily for text based sessions, screen sharing, white-boarding, and so on. In the case of a text based session, the IM client application has a graphical user interface which provides a window on the user's computer display for each session between a user and his or her contacts. The window displays a scrolling dialogue of the session between the first user and the contact.

Participating in an IM session is something busy people often do in parallel with performing other tasks. Such other tasks may include conducting additional IM sessions with other contacts, reading/authoring documents, programming, or any other activity.

Current systems provide an indication of a first user's activity status to a second user (e.g., via the second user's graphical display), for example, via a change of an icon associated with the first user, a change in a text description of the first user's status, and the like. The indication can be provided manually by the first user, or can be provided automatically by the first user's IM client application, based on the first user's activity on their computer.

Although current systems provide an indication of a user's status, there is a need for a system wherein a finer grained indication of a user's status is provided.

### SUMMARY

According to a first aspect, there is provided a system for communicating status data associated with a first user to a second user, for use with a first data processing system associated with a plurality of status events of the first user and comprising a first communication component for communicating status event data associated with the plurality of status events. The system comprises a status event handler for receiving communicated status event data; a weight component for determining weight data associated with the status event data; and a second communication component for communicating the weight data to a second data processing system.

Preferably, the second data processing system comprises a handler for receiving the weight data. More preferably, the handler uses the received weight data to determine an instruction associated with a status parameter of the first user. Still more preferably, the handler compares the received weight data against a profile to determine the instruction. In a preferred embodiment, the handler uses the instruction to change the parameter. Preferably, the parameter is displayed on a graphical display associated with the second data processing system. More preferably, the parameter is an audio parameter.

The system preferably comprises means for requesting the status event data from the first data processing system. The first communication component can be invoked according to a number of factors. In one example, a communication is sent from the second data processing system to the first data processing system, and the first communication component is invoked in response to the communication being received at the second data processing system. In another example, the first communication component is invoked in accordance with a pre-determined frequency. In yet another example, the first communication component is invoked in response to updated status event data associated with one or more of the plurality of status events. In yet another example, the first communication component is invoked in response to generation of status event data associated with a further status event. In yet another example, the first communication component is invoked in response to receipt of status event data associated with a further status event. In yet another example, the first communication component is invoked in response to the first data processing system establishing a session with a server. In yet another example, the first communication component is invoked in response to the first data processing system establishing a session with the second data processing system.

Preferably, the status event data further comprises, for each of the plurality of status events, any one of: a status event identifier and a status event type. More preferably, the first data processing system and the second data processing system each comprise an instant messaging application. Still more preferably, a parameter associated with a session window associated with the second user is displayed.

According to a second aspect, there is provided a method for communicating status data associated with a first user to a second user, for use with a first data processing system associated with a plurality of status events of the first user and comprising a first communication component for communicating status event data associated with the plurality of status events. The method comprises: receiving communicated status event data; determining weight data associated with the status event data; and communicating the weight data to a second data processing system.

According to a third aspect, there is provided a computer program comprising program code means adapted to perform the method as described above when the program is run on a computer.

The present invention is described in the context of instant messaging in order to provide a detailed description of embodiments of implementations of the invention and how these address the shortcomings of the prior art. However, the present invention could equally be applied to other applications and should not be construed as being limited to instant messaging applications.

### BRIEF DESCRIPTION OF THE DRAWINGS

The present invention will now be described, by way of example only, with reference to preferred embodiments thereof, as illustrated in the following drawings, wherein:

FIG. 1 is a block diagram of an instant messaging system to which the present invention may be applied;

FIG. 2 is a block diagram of a graphical display associated with a user;

FIG. 3 is a block diagram of an instant messaging system according to the present invention;

FIG. 4 is a flow chart showing the operational steps involved in a process according to the present invention;

FIG. 5A and 5B are depictions of a session window according to one embodiment; and FIG. 6A and 6B are depictions of a session window according to another embodiment.

### DETAILED DESCRIPTION

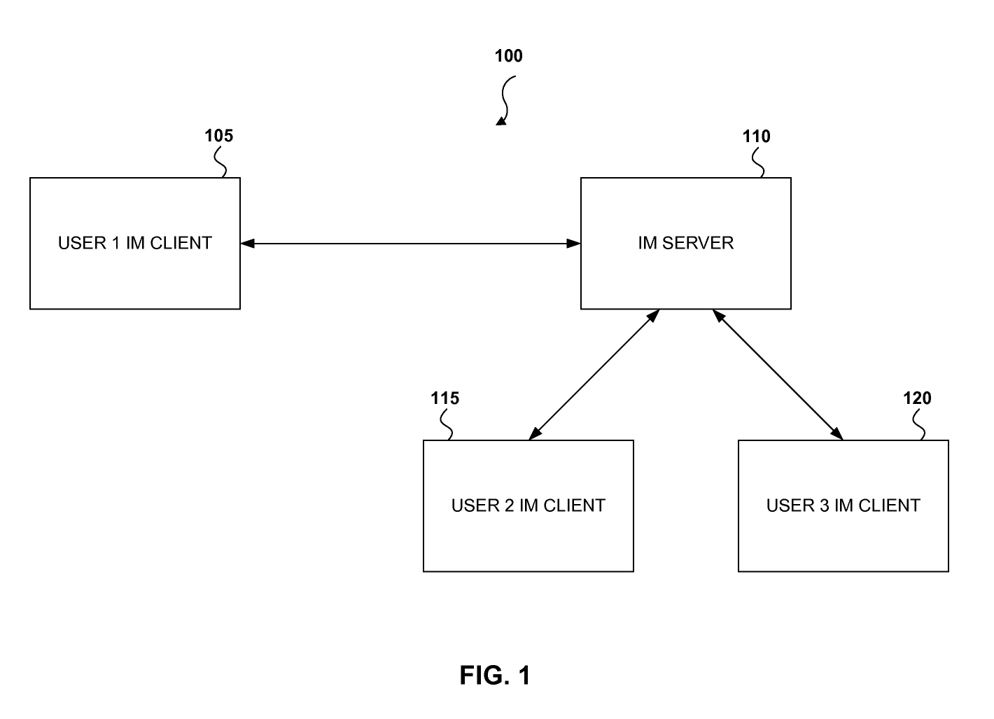

FIG. 1 shows an instant messaging system (100) to which an embodiment of the present invention may be applied. An instant messaging (IM) client application (105) runs on a computer of a first user. An IM service application, also referred to as an IM server (110), provides IM functionality via a network such as the Internet.

When the IM client application (105) logs on to the IM server (110), the IM server (110) checks a screen name and password. This may be done by a separate login server. The IM server (110) uses a communications protocol that allows for IM functionality. The IM client application (105) has a graphical user interface, which displays the instant messaging functionality to the first user on a graphical display of the first user.

The IM client application (105) includes contact list capabilities. A contact list of users the first user wishes to send and receive messages to and from is stored in the IM client application (105). This list of the screen names of the users is communicated to the IM server (110) so that when the listed users come online, the first user is notified by the IM server (110).

Each user has its own IM client application which runs on each of their computers. With reference to FIG. 1, there is shown an IM client application (115) associated with a second user and an IM client application (120) associated with a third user. When any of the users logs on, the first user's IM client application (105) is notified that they are online. Instant messages can then be sent and received in real time. Each message goes to the IM server (110), which routes the message to the intended recipient.

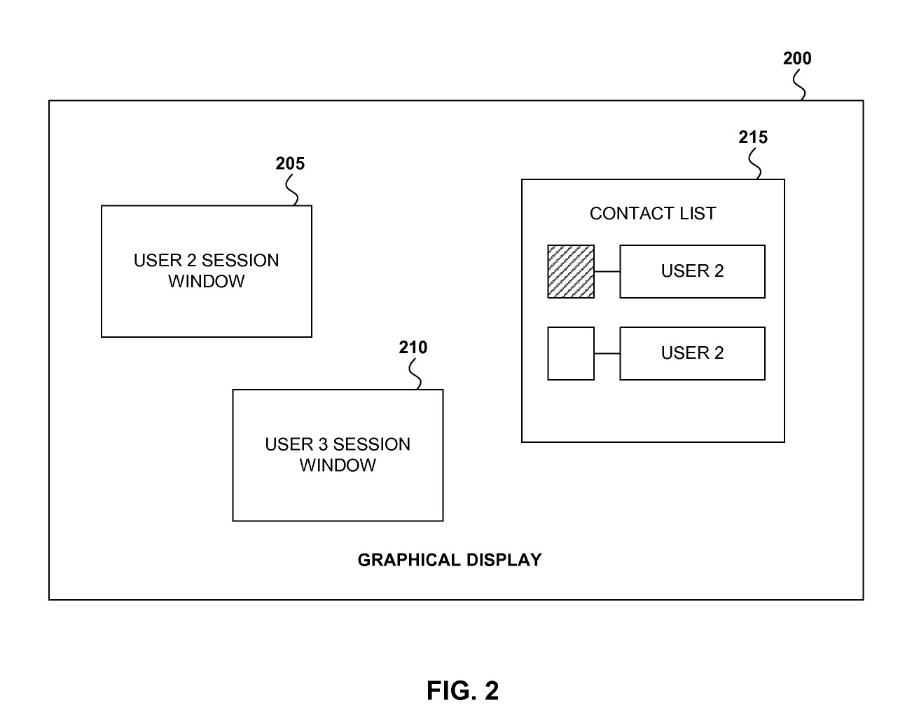

Referring to FIG. 2, a graphical display (200) of a user is shown which may be provided, for example, on a computer screen. The graphical display (200), sometimes referred to as a desktop, usually has a number of icons (not shown) representing applications available to the user to be run from the graphical display (200). An example of a graphical display is a Windows display system. Microsoft, Windows, Windows NT, and the Windows logo are trademarks of Microsoft Corporation in the United States, other countries, or both.

Applications which are currently operating on the graphical display (200) each have one or more graphical windows. In FIG. 2, the graphical user interface of an IM client application (105) for the user displays one or more IM windows (205), (210) each of which shows a session between the first user and the second user and third user respectively. When the first user enters text into a window to send, or reads received text, that window is in focus.

The graphical user interface (200) also displays a contact list (215), wherein an indication of status of each of the users is provided to the first user. With reference to FIG. 2, a shaded square associated with user 2 represents a status of “away” and a non-shaded square associated with user 3 represents a status of “active”.

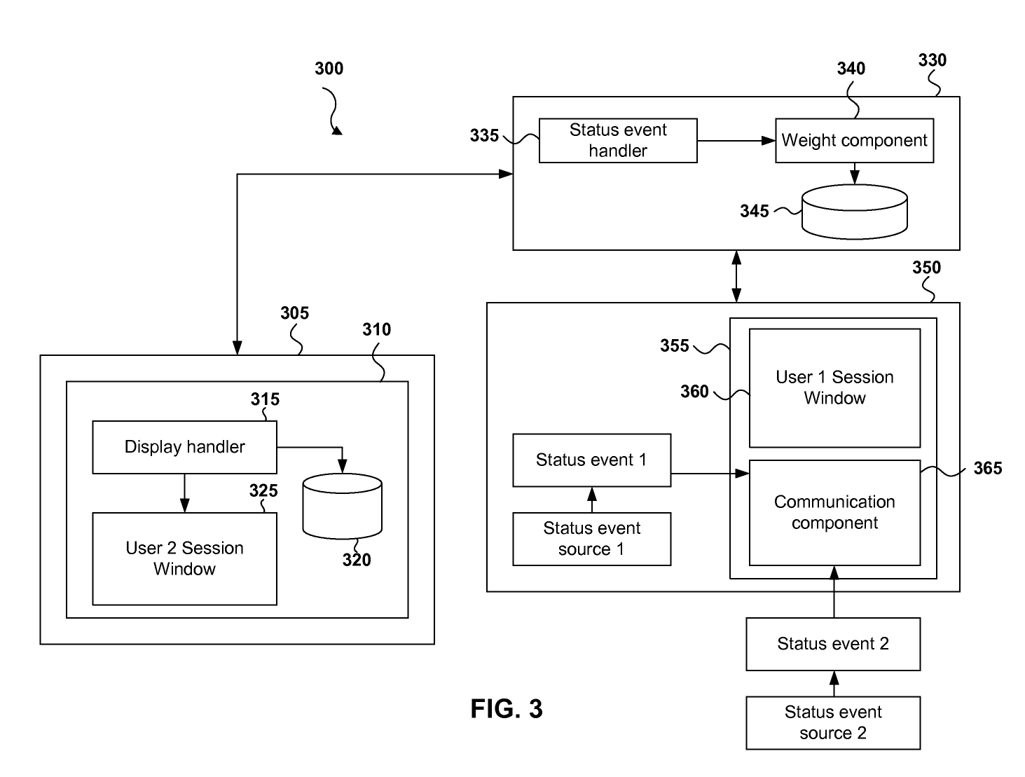

FIG. 3 is a block diagram of an instant messaging system (300) according to an embodiment of the present invention, where there is shown a computer (305) of a first user, an IM server (330) and a computer of a second user (350). An IM client application (310) runs on the first user's computer (305) and comprises a display handler (315), a profile (320), and a session window (325) associated with a session with the second user. The IM client application (310) comprises a contact list (not shown) of users the first user wishes to send and receive messages to. In a first example, the second user is listed in the contact list.

The IM server (330) comprises a status event handler (335), a weight component (340), and a storage means (345) comprising data associated with weights.

An IM client application (355) runs on the second user's computer (350) and comprises a session window (360) associated with a session with the first user and a communication component (365). The second user's computer (350) is associated with a plurality of status events that are generated by one or more status event sources. A status event is utilized to make a determination regarding a user's status.

In the first example, Status event source 1 generates Status event 1, wherein Status event source 1 is a keyboard associated with the second user's computer (350) and Status event 1 is a key press event in a session window associated with a third user. In the first example, Status event source 2 is a GPS system in a car associated with the second user and Status event 2 is a motion event associated with motion of the car. In the first example, Status event source 2 is located externally to the second user's computer (350).

It should be understood that a status event can comprise various types, for example:
A key press event in a session window that is currently in focus
A key press event in a window associated with another application (e.g., an e-mail application)
A focus event (i.e., focus gained, or focus not gained) associated with the session window (360) associated with the first user
A z-order event, wherein the z-order of the session window (360) associated with the first user is determined
A size event of the session window (360) associated with the first user, wherein the size of the session window (360) is compared with the size of other windows on the user's graphical display (e.g., other session windows associated with other users or other windows also including windows associated with other applications)
A window execution event associated with the session window (360) associated with the first user, wherein a determination is made as to whether the session window (360) is open or closed
A window execution event, wherein a determination is made as to whether a number of windows (e.g. session windows, or total number of windows (i.e. including windows associated with other applications)) open has reached a certain threshold
A window minimize event associated with the session window (360) associated with the first user, wherein a determination is made as to whether the session window (360) is minimized or not
A scroll event, wherein a determination is made as to whether the session window (360) associated with the first user is scrolled to the most recent line of text in the session
A pointer event, wherein a determination is made as to whether a pointer (e.g., a mouse pointer) is located over the session window (360) associated with the first user
An application execution event, wherein a determination is made as to whether a particular type of application is running on the second user's computer (350) (e.g., a presentation comprising slides)
An image event, wherein a determination is made as to whether the second user is at their computer (350) or not (e.g., by using still photographs or video captured with a camera)
An external system event, wherein a determination is made as to whether an external system to the user's computer (350) is being user (e.g., a telephone, a printer etc.)
An ambient noise event, wherein a determination is made as to whether the ambient noise has reached a certain threshold
An IM client application option event wherein a determination is made as to which option regarding status has been selected by the second user (e.g., “away”, “online” etc.)
A graphical display change event, wherein a determination is made as to whether a state of the graphical display of the second user has changed, for example, whether the state has changed due to a screen saver being invoked
A type rate event, wherein a determination is made regarding the rate at which the second user types in the session window (360) associated with the first user
A lock event, wherein a determination is made as to whether the second user has locked their computer (350)
A time event, wherein a determination is made regarding a time period since the second user last interacted with the session window (360) associated with the first user. For example, wherein an interaction comprises a key press event, a window focus event, etc.; and
A selection event, wherein a determination is made as to whether the second user selects (and optionally, interacts with) a number (and/or a particular set) of windows (e.g., session windows or windows including windows associated with other applications); a further determination can be made as to whether the selection occurs without the second user selecting (an optionally, interacting with) the session window (360) associated with the first user

It should be understood that the first user's IM client application (310) can also comprise a communication component (365) and the first user's computer (305) can also be associated with one or more status event sources. However, these components have not been shown for clarity. It should be understood that the second user's IM client application (355) can also comprise a display handler and a profile. However, these components have not been shown for clarity.

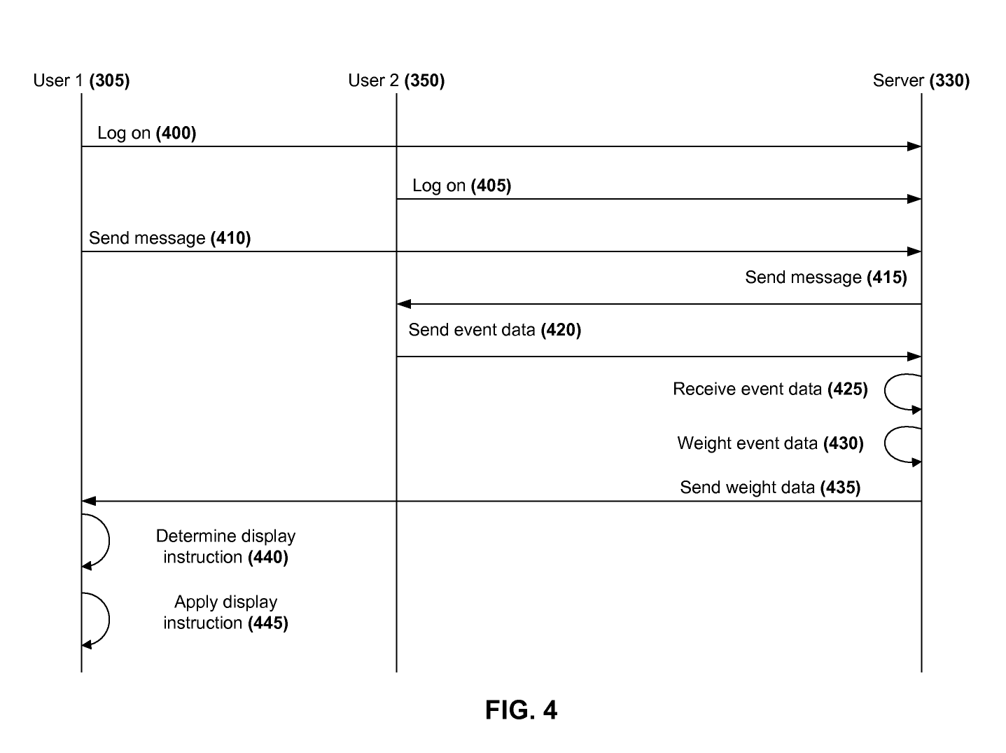

The present invention will now be described with reference to FIGS. 3-5. With reference to FIG. 4, a first user logs on (step 400) to the IM server (330) via their IM client application (310) and a second user logs on (step 405) to the IM server (330) via their IM client application (355).

In response to the users logging on the IM server (330), a first session comprising one or more data channels is established between the first user's IM client application (310) and the IM server (330) and a second session comprising one or more data channels is established between the second user's IM client application (355) and the IM server (330). Since the second user is online and is listed in the contact list associated with the first user, in response to the second user logging on to the IM server (330), the IM server (330) sends a notification that the second user is online via a data channel associated with the first session, to the first user's IM client application (310). An indication of the second user's status (i.e., wherein the status is “online”) is provided to the first user (e.g., via an icon in the first user's contact list).

Next, the first user sends (step 410) a message directed to the second user to the IM server (330). In response to the first user sending a message, the first user's IM client application (310) invokes a session window (325) associated with the second user, which is displayed on the first user's graphical display. Furthermore, in response to the first user sending a message, a first sub-session within the first session and a second sub-session within the second session are established, such that data sent via one or more data channels associated with the first sub-session is identified as being from the first user and targeted to the second user and data sent via one or more data channels associated with the second sub-session is identified as being from the second user and targeted to the first user.

Next, the IM server (330) sends (step 415) the message to the second user's IM client application (355) via a data channel associated with the second sub-session. This causes the second user's IM client application (355) to invoke a session window (360) associated with the first user, which is displayed on the second user's graphical display.

In response to the second user's IM client application (355) receiving the message, the communication component (365) is invoked to send (step 420) status event data to the IM server (330). Alternatively, the IM server (330) can proactively request status event data from the communication component (365).

The communication component (365) listens for status event data from Status event source 1 and Status event source 2 (for example, for a pre-determined time threshold). In the first example, Status event source 1 generates Status event 1, that is, a key press event in a session window associated with a third user and Status event source 2 generates Status event 2, that is a motion event associated with motion of the car (wherein a state associated with Status event 2 is “0” i.e. indicating no motion).

The communication component (365) receives Status event 1 and Status event 2 and sends status event data (e.g., an identifier associated with Status event 1 and an identifier associated with Status event 2) associated with Status event 1 and Status event 2 to the IM server (330) via a data channel associated with the second sub-session.

The status event handler (335) in the IM server (330) receives (step 425) the status event data and passes the status event data to the weight component (340). The weight component (340) compares the status event data against the storage means (345) comprising data associated with weights, in order to find an entry associated with Status event 1 and an entry associated with Status event 2.

A representation of the storage means (345) is shown below in Table 1, comprising elements associated with a status event identifier and an associated weight (as a percentage). The weight can be associated with the activity of a user, inactivity of a user, and so forth. In the first example, the weight is associated with the activity of a user:

TABLE 1

| Status event identifier | Weight (%) |
|---|---|
| Status event 1 | 50 |
| Status event 2 | 50 |

In response to the comparison, entries are found in the storage means (345) and the weight component (340) reads the associated weight data (i.e., 50% and 50%) in order to weight (step 430) Status event 1 and Status event 2.

In the first example, a formula for calculating a total weight is applied by the weight component (340). In one embodiment, a formula which divides the sums of the weights by the total sum of all weights is applied. In the first example, a formula which averages the weights of the status events is applied. A resulting weight of 50% is calculated by the weight component (340). The formula can be generated by a systems administrator or by a user.

Next, the IM server (330) sends (step 435) the calculated weight data to the first user's IM client application (310) via a data channel associated with the first sub-session.

The display handler (315) receives the weight data (i.e., “50%”) and compares the weight data against the profile (320), in order to determine (step 440) a display instruction, wherein the display instruction controls display of a display parameter associated with a contact's status.

Preferably, the first user is provided with one or more display applications associated with displaying one or more display parameters associated with a contact's status. Preferably, a display application provides data associated with one or more display parameters associated with an IM client application (more preferably, a session window). For example the data comprises: a type of display parameter and how the display parameter can be changed.

In the first example, a display application (not shown) provides data associated with a display parameter (i.e., an icon associated with the session window) and how the display parameter can be changed (i.e., shading associated with the icon can be changed from 0% (no shading) to 100% (fully shaded)).

A representation of the profile (320) is shown below, comprising elements associated with weight data and an associated display instruction associated with the display parameter (i.e., the icon) and a display change to the display parameter (i.e., shading of the icon):

TABLE 2

| Weight (%) | Display Instruction |
|---|---|
| 50% | Render icon at 50% shaded |
| 0 | Render icon at 0% shaded |

The display handler (315) compares the weight data against the profile (320) and finds a field comprising matching weight data. Next, the display handler (315) reads the field to determine the associated display instruction (i.e., “Render icon at 50% shaded”).

It should be understood that an IM client application of a user holds a reference in memory to an invoked session window associated with another user. The reference comprises data associated with the another user (e.g., an address associated with the another user). Thus, the IM client application (310) looks up the references held in memory in order to determine a session window to which the display instruction is to be applied. It should be understood that if a session window is not open, a session window is invoked by the IM client application.

Next, the display handler (315) applies (step 445) the display instruction to the session window (325) associated with the second user.

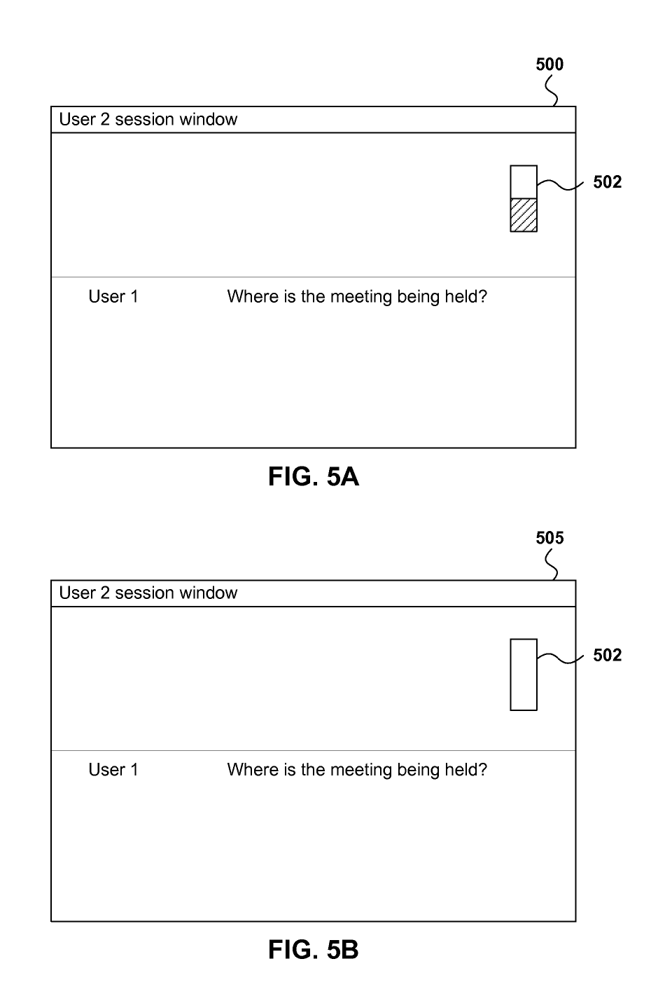

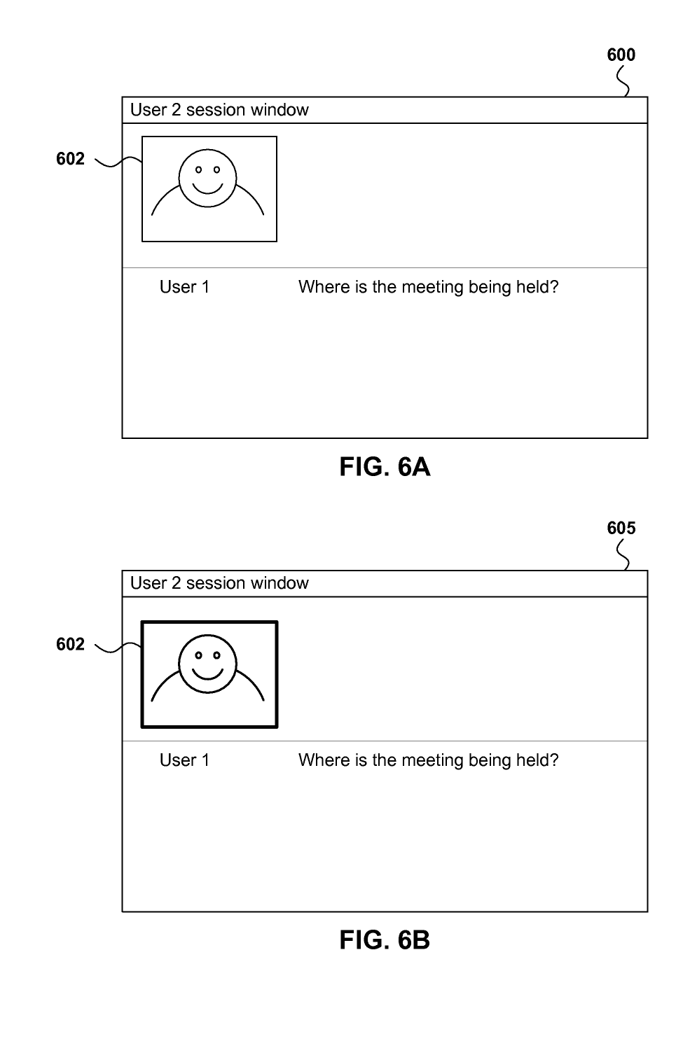

Thus, according to one embodiment, an icon (502) associated with the session window (325) associated with the second user is displayed as 50% shaded as shown in FIG. 5A. An example of the icon (502) displayed as 0% shaded, indicating no activity from the second user is shown in FIG. 5B.

According to another embodiment, a display application (not shown) provides data associated with a display parameter (i.e., a border surrounding a portrait photo of the second user associated with the session window) and how the parameter can be changed (i.e. opacity of the border can be changed from 0% (no opacity) to 100% (fully opaque)). An example of a border (602) surrounding a portrait photo of a second user displayed in the session window (325) of n% opacity indicating activity from the second user (i.e., wherein >0n<100) is shown in FIG. 6A. An example of the border (602) of 0% opacity (no opacity) is shown in FIG. 6B.

Preferably, the communication component (365) is invoked in accordance with a frequency. In the first example, the first user sets the frequency of ten minutes. It should be understood that the frequency can also be set by a systems administrator. The first user's IM client application (310) sends frequency data to the IM server (335) (it should be understood that the frequency data can be communicated before a message is sent by the first user directed to the second user, or after a message is sent by the first user directed to the second user). The IM server (330) sends the frequency data to the second user's IM client application (355). It should be understood that the frequency data can be communicated before a message is sent by the first user directed to the second user, or after a message is sent by the first user directed to the second user.

When the IM server (330) sends a message from the first user to the second user's IM client application (335), the communication component (365) is invoked to send (step 420) status event data to the IM server (330) as described above. In the first example, as described above, this results in an icon (502) associated with the session window (325) associated with the second user being displayed as 50% shaded, as shown in FIG. 5A.

The communication component (365) is invoked again in accordance with the frequency data and with reference to a system clock. Thus, the communication component (365) is invoked again after a ten minute period from the time at which the communication component (365) was first invoked.

In the first example, no status event data is received by the communication component (365). The communication component (365) sends a notification indicating that status event data has not been received, to the IM server (330). The IM server (330) receives the notification and sends the notification to the first user's IM client application (310).

In the first example, the display handler (315) receives the notification and selects a display instruction by utilizing a default setting for the display instruction associated with receipt of the notification. In the first example, the display handler (315) applies the display instruction to the session window (325) associated with the second user. In the first example, an icon (502) associated with the session window (325) associated with the second user is displayed as 0% shaded.

In one embodiment, the communication component associated with a user's IM client application is continuously invoked in accordance with frequency data. In another embodiment, the communication component associated with a user's IM client application is invoked in accordance with frequency data until a threshold is met (e.g., a time threshold).

Alternatively, the communication component is invoked when a state associated with a status event changes (e.g. a state associated with a motion event associated with motion of a car changes from “0”(no motion) to “1”(motion)).

Alternatively, the communication component is invoked when a new status event is generated.

Alternatively, the communication component is invoked when the second user's IM client application (355) establishes a session with the IM server (330). That is, weight data can be sent to the first user's computer (305) when the second user is online (i.e., before the first user sends a message to the second user).

Alternatively, in a P2P environment, the communication component is invoked when the second user's IM client application (355) establishes a session with the first user's computer system (305).

Advantageously, by invoking the communication component more than once, a user is provided with a regularly updated indication of a contact's status.

In the first example, although the weight data in the storage means and the weight data in the profile match, the weight data in the storage means can correspond to the weight data in the profile. For example, the weight data in the storage means can be equivalent to the weight data in the profile. In another example, the weight data in the storage means (e.g., 50%) can correspond to a range of weight data in the profile (e.g., 40%-60%) or vice versa.

Although in the first example, weight data is sent (step 435) to the first user's IM client application (310), any other data associated with a user's status can be sent. For example, data regarding a type of status event as well as weight data can be sent (e.g., “<Type=keyboard event; Weight=50%><Type=motion event; Weight=50%>”). However, due to privacy concerns for a user's contact, it is preferable not to send data regarding a type of status event.

It should be understood that although the present invention has been described with reference to a system comprising a centralized server and associated clients, the present invention can be implemented in other systems, for example, in a peer to peer (P2P) system. In a P2P system, a client communicates with a server in order to obtain a network address of another client. The clients can then send messages directly to each other, without the messages being sent through the server.

It should be understood that although the components of the system of the present invention (as represented in FIG. 3, for example) have been described as residing across systems in a distributed system, it should be understood that the components can reside in any computer system. For example, all of the components can reside on each client system.

Although the storage means described herein comprises fields associated with a status event identifier and an associated weight as a percentage, the storage means can comprise any other data. For example, the storage means can comprises data regarding status event identifiers associated with status events associated with a plurality of users. Furthermore, weight data can be represented in a variety of ways (e.g., as a fraction).

Preferably, one or more display applications are provided as plug-ins to the IM client application (e.g., wherein a user can download the plug-ins as required). If a plurality of display applications is downloaded, the user is preferably provided with a corresponding plurality of options (e.g., via a menu display), wherein the user can select a display application to control the way in which an indication of a contact's status is provided to the user. A display application can control a display parameter associated with one or more session windows. Thus, a user can select a plurality of display applications to control a plurality of display parameters associated with a plurality of session windows.

Although the profile described herein comprises fields associated with weight data and an associated display instruction, the profile can comprise any other data. For example, the profile can comprise sub-profiles, wherein the weight data is associated with a plurality of sets of display instructions. Then in step 440 above, depending on the particular display instruction option that a user has set for a session window, the appropriate profile is accessed (for example, by comparing an identifier associated with a display instruction option against a corresponding identifier associated with a profile for that display instruction).

It should be understood that although as described herein, an indication of a contact's status is provided by causing a change to the display of an icon and to a contact's portrait photo, an indication can be provided in any other way. In one example, changes can be made to display characteristics of text displayed within a session window (e.g., changes are made to opacity of the text). In another example, changes to a textual notification (e.g., “User 2 is away”; “User 2 is online” etc.) can be made (e.g.,, one or more notification within the session window, within a pop-up window etc.). In yet another example, changes to an audio notification can be made (e.g., alarms of varying pitch).

It should be understood that the weight data can be generated in a number of ways. For example, the weight data can be generated manually by a system administrator or a user (e.g. a user who is the recipient of a message, or a user who is sending a message and is provided with an indication of the recipient's status). Alternatively, the weight data can be generated automatically, for example, by monitoring a user's activity against generated status events.

What is claimed is:

1. A system for communicating status data associated with a first user to a second user, for use with a first data processing system associated with a plurality of status events of the first user and comprising a first communication component for communicating status event data associated with the plurality of status events; the system comprising:
a status event handler for receiving communicated status event data;
a weight component for determining weight data associated with the status event data; and
a second communication component for communicating the weight data to a second data processing system.

2. A system as claimed in claim 1, wherein the second data processing system comprises a handler for receiving the weight data.

3. A system as claimed in claim 2, wherein the handler uses the received weight data to determine an instruction associated with a status parameter of the first user.

4. A system as claimed in claim 3, wherein the handler compares the received weight data against a profile to determine the instruction.

5. A system as claimed in claim 4, wherein the handler uses the instruction to change the parameter.

6. A system as claimed in claim 1, further comprising means for requesting the status event data from the first data processing system.

7. A system as claimed in claim 1, wherein the status event data further comprises, for each of the plurality of status events, any one of: a status event identifier and a status event type.

8. A system as claimed in claim 1, wherein the first data processing system and the second data processing system each comprise an instant messaging application.

9. A method for communicating status data associated with a first user to a second user, for use with a first data processing system associated with a plurality of status events of the first user and comprising a first communication component for communicating status event data associated with the plurality of status events; the method comprising:
receiving communicated status event data;
determining weight data associated with the status event data; and
communicating the weight data to a second data processing system.

10. A method as claimed in claim 9, further comprising receiving the weight data.

11. A method as claimed in claim 10, further comprising using the received weight data to determine an instruction associated with a status parameter of the first user.

12. A method as claimed in 11, further comprising comparing the received weight data against a profile to determine the instruction.

13. A method as claimed in claim 12, further comprising using the instruction to change the parameter.

14. A method as claimed in claim 9, further comprising requesting the status event data from the first data processing system.

15. A method as claimed in claim 9, wherein the status event data further comprises, for each of the plurality of status events, any one of: a status event identifier and a status event type.

16. A method as claimed in claim 9, wherein the first data processing system and the second data processing system each comprise an instant messaging application.

17. A computer program product for communicating status data associated with a first user to a second user, for use with a first data processing system associated with a plurality of status events of the first user and comprising a first communication component for communicating status event data associated with the plurality of status events; the computer program product comprising a computer readable medium having computer readable program code, the computer readable program code comprising:
computer readable program code configured to receive communicated status event data;
computer readable program code configured to determine weight data associated with the status event data; and
computer readable program code configured to communicate the weight data to a second data processing system.

18. The computer program product as claimed in claim 17, wherein the second data processing system comprises computer readable program code configured to receive the weight data.

19. The computer program product as claimed in claim 18, wherein the computer readable program code configured to receive the weight data uses the received weight data to determine an instruction associated with a status parameter of the first user.

20. The computer program product as claimed in claim 19, wherein the computer readable program code configured to receive the weight data compares the received weight data against a profile to determine the instruction.
